(19) United States
(12) Patent Application Publication
(10) Pub. No.: US 2025/0053555 A1
(43) Pub. Date: Feb. 13, 2025

(54) MULTI-PLATFORM CONTACT INFORMATION SYSTEM

(71) Applicant: Contax LLC, Kill Devil Hills, NC (US)

(72) Inventor: Leeor Golasa, Kill Devil Hills, NC (US)

(73) Assignee: Contax LLC, Kill Devil Hills, NC (US)

(21) Appl. No.: 18/797,944

(22) Filed: Aug. 8, 2024

Related U.S. Application Data
(60) Provisional application No. 63/531,658, filed on Aug. 9, 2023.

(51) Int. Cl. G06F 16/23; G06F 16/27

(52) U.S. Cl. CPC G06F 16/2358; G06F 16/27

(57) ABSTRACT

The present disclosure provides an approach for implementing a multi-platform contact information system. The approach receives first contact information data from a first user device corresponding to a first user. The first contact information data comprises a plurality of data entries corresponding to a plurality of different platform connection types. The approach stores the first contact information data on a plurality of second user devices corresponding to a plurality of second users. Then, the approach detects a change to the first contact information by the first user. In response to detecting the change to the first contact information, the approach stores the change to the first contact information on the plurality of second user devices. In turn, the approach provides a notification to the plurality of second users that indicate the change to the first contact information.

### TECHNICAL FIELD

Aspects of the present disclosure relate to contact integration, and more particularly, to a multi-platform contact information system that streamlines the process of managing and synchronizing both conventional contact information and modern-era contact information.

### BACKGROUND

Mobile devices, such as smartphones, tablets, laptops, etc., are versatile tools that serve a wide range of purposes. Over the years, mobile devices have transitioned from their primary function of making phone calls and contacting people to becoming powerful platforms for engaging in social media. Today, smartphones and tablets have become a gateway to a vast array of social networks and online communities, enabling users to connect, share, and interact with others. With the rise of mobile apps and advanced connectivity, users are able to access social media platforms, browse news feeds, post updates, share photos and videos, join virtual communities, and even livestream experiences to a global audience.

Mobile devices use contact lists to streamline and enhance communication in various ways. The contact lists serve as a centralized repository of important contact information, which allows users to easily find and reach out to their contacts without the need to remember or manually input each individual's details. The contact list also plays a role in caller identification, as mobile devices can match incoming calls with saved contacts, displaying the caller's name and photo if available.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the scope of the described embodiments.

FIG. 1 is a block diagram that illustrates an example system, in accordance with some embodiments of the present disclosure.

FIG. 2 is a data flow diagram that illustrates an example for registering an account, in accordance with some embodiments of the present disclosure.

FIG. 3 is a data flow diagram that illustrates an example for signing into an account, in accordance with some embodiments of the present disclosure.

FIG. 4A is a data flow diagram that illustrates an example for managing fields, in accordance with some embodiments of the present disclosure.

FIG. 4B is a data flow diagram that illustrates an example for managing groups, in accordance with some embodiments of the present disclosure.

FIG. 5 is a data flow diagram that illustrates an example for creating, accepting, and rejecting contact requests, in accordance with some embodiments of the present disclosure.

FIG. 6 is a data flow diagram that illustrates an example for befriending a public profile, in accordance with some embodiments of the present disclosure.

FIG. 7A is a data flow diagram that illustrates an example for befriending a private profile using QR (quick response) codes, in accordance with some embodiments of the present disclosure.

FIG. 7B is a data flow diagram that illustrates an example for befriending a local contact, in accordance with some embodiments of the present disclosure.

FIG. 8 is a block diagram of an example computing device that may perform one or more of the operations described herein, in accordance with some embodiments of the present disclosure.

### DETAILED DESCRIPTION

As discussed above, mobile devices are versatile tools that serve a wide range of purposes. While mobile devices are versatile, they also come with their share of challenges, such as maintaining up-to-date contact information and tracking social media information. Contact information changes frequently due to users changing phone numbers, email addresses, job titles, etc. A challenge lies in manually updating these changes on a mobile device, especially with a large contact list, which can be time-consuming and tedious to regularly review and update each entry. In addition, maintaining contact information across multiple devices can lead to synchronization challenges. For example, if multiple mobile devices or contacts are stored in different accounts or platforms, ensuring that all devices have the most recent and accurate information can be time consuming and prone to errors.

Furthermore, mobile contact applications typically have predefined fields for storing information such as phone numbers, email addresses, and physical addresses. The limited fields can make it difficult to maintain a comprehensive and detailed contact record. For example, with the prevalence of social media, many users prefer to connect and communicate through various social media platforms. Users frequently change their usernames, profile pictures, or even delete their accounts altogether. This can make it difficult to keep track of someone's digital presence, as their social media handles might change frequently, and their information becomes outdated. Additionally, privacy concerns and shifting preferences can lead individuals to modify their privacy settings, limiting the visibility of their accounts, which adds another layer of complexity to staying connected. Moreover, the rapid emergence of new platforms and the decline of others further compounds the difficulty, as staying informed about the latest trends and preferences becomes a constant effort.

Yet another challenge is in the sheer volume of connections and contacts users accumulate over time can make it challenging to remember and update everyone's information. Whether it is colleagues, friends, family members, or acquaintances, each person's contact details and social media accounts need to be organized and regularly reviewed to ensure accuracy. Failure to do so can lead to missed opportunities, outdated information, and a disjointed digital network.

The present disclosure addresses the above-noted and other deficiencies by enabling seamless integration of contact information within the context of a social media-driven world. The present disclosure extends beyond social media alone, as individuals find themselves utilizing multiple phone numbers for diverse purposes such as personal, work-related, or international travel scenarios. The present disclosure streamlines the process of sharing contact information such as phone numbers, usernames, and handles by enhancing the functionality of the contact book to align with the demands of the modern era. The present disclosure offers smooth synchronization and real-time updates of contact books across devices by utilizing the inherent capabilities offered by various platforms, together with secure communication protocols with a centralized server. By tracking changes made by an individual user and propagating those updates to their contacts, the present disclosure ensures that modifications, such as switching personal phone numbers, social media handles, etc. can be effortlessly managed. When a user updates their contact information (e.g., phone number, social media handles, etc.), relevant contacts are promptly notified of the changes, and the updated contact information is automatically synchronized and shared with the relevant contacts, thereby eliminating the need for manual updates by the relevant contacts.

The present disclosure also includes robust measures to address security concerns. Users are given the option to configure their profile settings as “private,” making it concealed from external visibility, or public, enabling unrestricted access, which is particularly beneficial for businesses. Moreover, the present disclosure offers the capability to selectively grant access to details for individual contacts, further enhancing the platform's security features and giving users greater control over their shared data. In some embodiments, a user may create personal accounts, public accounts, or a combination thereof. A personal account is a private account that is searchable between contacts. A public account may be set to private or public. The user, such as a celebrity or business, stores all their social media handles across different social media platforms that the user is interested in sharing. Then, if the user sets the private account to public, other users can locate/follow the user through a “search” and receive updates whenever the user changes/adds/deletes contact or social media information. When a user creates a public account and sets it to private, other users may still search for the user but the other users are required to request to join the account and the user accepts or denies their requests accordingly.

In some embodiments, when a user deletes or changes contact information, the contact information is automatically deleted or changed on the user's other devices. In some embodiments, if a user has notifications turned in, the user is also notified of the deletion/change. In some embodiments, when a user creates a new social profile and adds a new social media handle to a field, the new social media handle is shared with the user's contacts. In some embodiments, a user adds other types of content into fields, such as pictures, notes, etc., which is then shared with the user's contacts. In some embodiments, the user may add a field to their profile for another user to act upon, such as “subscribe to my xyz channel.” In this embodiment, the other user is redirected to the user's xyz channel to complete the subscription.

The present disclosure also enables users to share information with other contacts through the convenient methods of scanning QR codes or sharing invite links. Users may select information they wish to share with an individual and generate a unique QR code or link. The intended recipient may then access the details that have been shared.

Furthermore, the present disclosure offers offline accessibility, enabling users to access all their data, including contacts, personal information shared by contacts, and their own personal information, even without a network connection. Through seamless synchronization, users can conveniently synchronize their data and that of their contacts the next time they are online, ensuring that all the information remains readily available offline regardless of current network connectivity.

The following is a list of terms and their definitions:

Account: An account refers a unique digital identity of an individual user and serves as a record that grants access to various features and services provided by the platform. When a user registers on the platform, an account is created requiring the provision of personal information such as a username, password, and phone number. This information is subsequently used for authentication during the sign-in process.

Field: A field represents information that can be associated with a particular profile. Fields allow users to assign relevant data to their contacts. Each field can be selectively shared with chosen contacts, ensuring control of information sharing. When a user updates a field, notifications are sent to contacts who meet the criteria ensuring the contacts stay up to date with the changes. Fields can include web links (URLs), email addresses, phone numbers, social media handles, notes, images, etc. Fields can also leverage third-party APIs, enabling integration with external services or platforms.

Group: A group refers to a collection of contacts that can be organized based on criteria, such as shared inter relationships or purposes. Groups allow users to categorize and manage their contacts more effectively, thereby facilitating streamlined communication and collaboration within designated groups.

Profile: Profiles allow users to manage sets of contacts, groups, and fields. Profiles provide flexibility organizing, managing, and interacting with contacts in different ways based on a chosen profile. A profile represent virtual representation of the user's identity within the platform, enabling a user to personalize their experience interactions based on different contexts or purposes.

Contact Request: Expresses an intention to connect and engage with another user on the multi-platform contact information system, also referred to as an EON platform. This request initiated by one user and directed towards another user, who has the option to accept or decline the request. If the con request is accepted, the users become contacts on the platform and they can interact with each other.

Below is a table that includes a high-level summary of the system's technical elements. This overview aims to provide an understanding of the technological components employed within the system.

| Functionality | Technology | Description |
|---|---|---|
| Authentication | Supertokens API | Supertokens is an open-source and secure |
| | | technology that provides users with the option |
| | | to self-host their data. It offers a versatile and |
| | | flexible solution that puts the user in command |
| | | of their data and allows for seamless |
| | | customization to align with individual |
| | | requirements. |
| Authorization | Custom-built | Customized access control that is in line with |
| | | particular requirements, increased security |
| | | through careful use of authentication and |
| | | permission controls, and scalability to handle |
| | | changing needs. |
| Synchronization of | Custom-built NodeJS | Leveraging custom code and implementation |
| contacts | implementation using | grants the freedom to design and incorporate a |
| | NestJS framework | wide range of functionalities according to |
| | | individual needs and preferences. |
| Verification service | Supertokens API | Supertokens provides complimentary E-Mail |
| (E-Mail, SMS) | | and SMS services, which prove advantageous |
| | | during the initial stages, particularly for a |
| | | smaller user base. These services effectively |
| | | reduce development time, offering a |
| | | convenient solution for essential |
| | | communication needs, while allowing |
| | | resources to be allocated more efficiently to |
| | | other critical aspects of the project. |
| Data storage for | PostgreSQL | PostgreSQL enables robust database |
| contacts and | | management. It ensures data integrity and |
| contact's | | provides excellent performance making it a |
| information | | cost-effective choice for organizations. |
| EON Business | Custom-built NodeJS | Offers power, scalability, and versatility, |
| Logic | implementation using | making it an excellent choice for current needs. |
| | NestJS framework | Importantly, it provides the flexibility to |
| | | smoothly migrate to a microservices |
| | | architecture in the future, especially when the |
| | | user base would have grown significantly, |
| | | ensuring the system can effectively |
| | | accommodate the growing demands. |
| Android and iOS | Flutter | Flutter provides a fast and efficient |
| Application | | development process with a single codebase, |
| | | reducing time and effort. Its rich set of |
| | | customizable UI widgets, along with the |
| | | framework's native-like performance, enables |
| | | the creation of visually appealing and |
| | | responsive apps for both iOS and Android |
| | | platforms. |

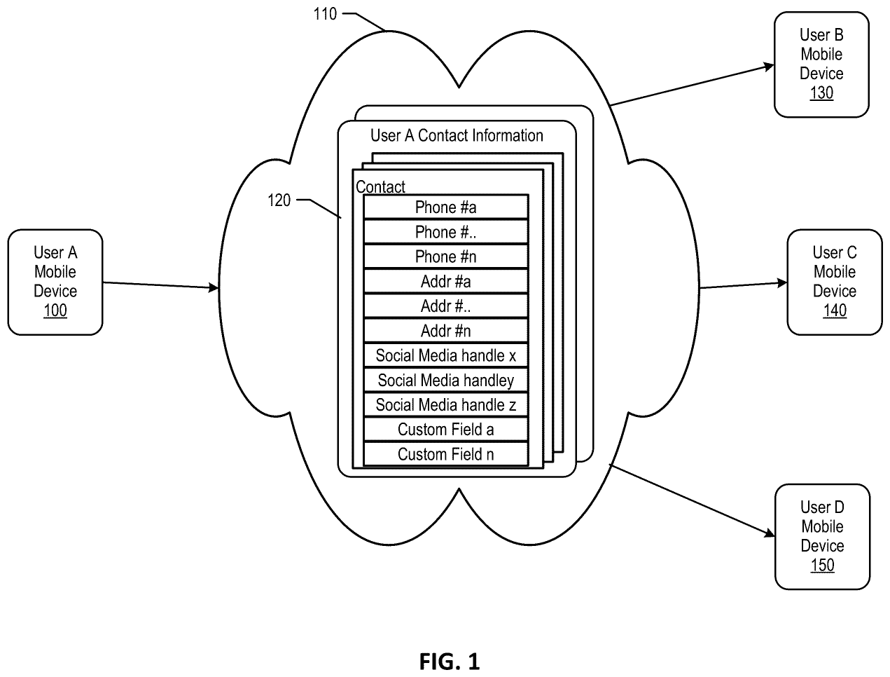

FIG. 1 is a block diagram that illustrates an example system, in accordance with some embodiments of the present disclosure. As discussed in further detail below, user A (via user A mobile device 100) creates contact information 120 using fields that may include multi-platform data such as phone numbers, addresses, social media handles, etc. Then, user A may share all, or a portion of, the contact information with all, or a portion of, users B, C, and D via their corresponding mobile devices (user B mobile device 130, user C mobile device 140, and user D mobile device 150) via computer network 110. As discussed below in more detail, user A may create private accounts, public accounts, or a combination thereof to share information with close contacts and the general public.

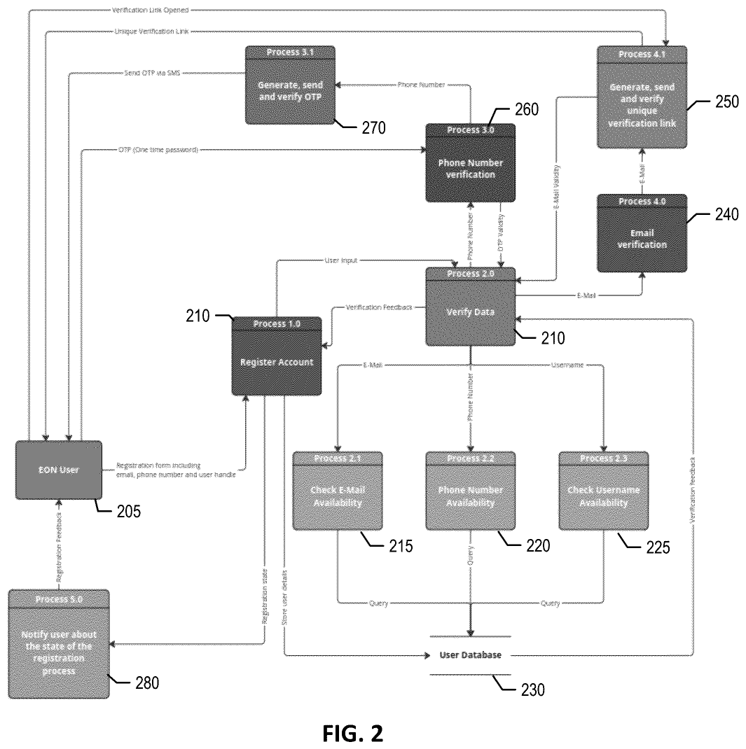

FIG. 2 is a data flow diagram that illustrates an example for registering an account, in accordance with some embodiments of the present disclosure. Authentication and authorization systems play a crucial role in software applications by establishing user access to the software while maintaining a high level of security by ensuring secure access to sensitive data protecting against unauthorized use. The authentication system consists of multiple components working together provide a robust and seamless authentication. These components include a client-side interface, a server-authentication engine, and a secure database for storing user credentials and authentication records. Additionally, authentication can be accomplished through third-party providers, leveraging their respective authentication services and protocols. This integration allows users to use their existing accounts made by these providers to authenticate and access the platform. Authentication involves the utilization of industry-standard cryptographic algorithms, secure communication protocols, and efficient storage techniques, and leverages industry best practices and standards to ensure interoperability compatibility with other platforms and technologies.

Each user may create a single account with the ability to have multiple profiles. The account serves as the primary identification for the user and provides necessary credentials for authentication. Profiles enable users to have distinct sets of contacts and customize the data that be shared with those contacts. Additionally, profiles provide the ability to organize, manage, and interact with contacts in different ways, offering a level of customization and differentiation based on the selected profile. For example, a user may have a private profile and a public profile. Private profiles are designed for personal use, while public profiles cater to businesses and celebrities. The key distinction lies in discoverability, as private profiles are searchable through the platform's search bar, while public profiles may be found and have the capability to share select fields with non-contacts, expanding their reach beyond established connections. In some embodiments, private profiles are not publicly searchable, while public profiles can be discovered by other users.

During account registration 210, user 205 provides essential information, verifies their email address and/or phone number, creates a unique user identifier, and accepts terms and conditions. The registration process begins with the user selecting their preferred sign-up method, after which they navigated to the registration form. They have the option to sign up directly by providing their personal details or using third-party sign-in providers. When opting for a third-party sign-in provider, certain fields in the registration form may be automatically populated based on the data obtained from the selected service provider. In some embodiments, users do not have to provide a password since authentication is conducted through the selected third-party service.

The registration form requires the user to fill in his personal details, such as their name, email, phone number, username, and a profile picture. As the user fills out the registration form, the system checks availability of the entered data (215, 220, 225) by querying the user database 230 and provides instant feedback regarding its status, indicating whether the username is already registered or available for use. The email verification process 240 generates a verification link (250), which is then dispatched to the email address provided by the user. This procedure serves to validate the ownership of the email and ensures that it belongs to the user in question. The phone number is verified (260) through the generation and validation of an OTP (One-Time Password) (270). OTP process involves generating a unique temporary code and sending it to the user's provided phone number.

When all the checks are successfully completed, the user is notified of the successful registration (280) and is automatically signed in. In case any errors or issues are identified during the backend checks, an appropriate error message is displayed to the user. In some embodiments, the error message provides guidance on correcting the fields or taking necessary actions to resolve the issues and complete the registration process successfully.

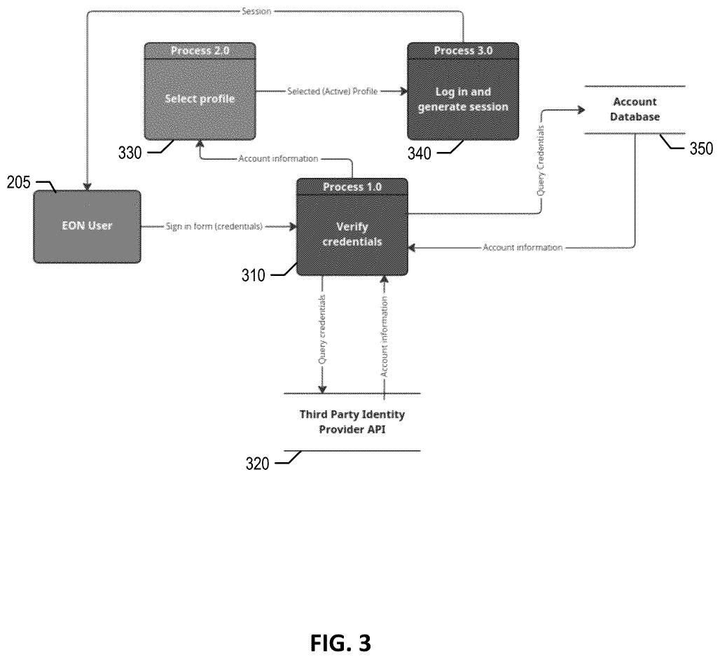

FIG. 3 is a data flow diagram that illustrates an example for signing into an account, in accordance with some embodiments of the present disclosure. The signing-in process involves authenticating user credentials 310 to grant access to the platform and associated features. The platform provides user 205 with multiple options for logging in (330, 340), including using their phone number and password, their email and password, or through third-party identity providers (320). Upon successful verification of the provided credentials via account database 350, user 205 is navigated to the home screen. In cases where user 205 has multiple profiles and no active profile was previously selected, user 205 is redirected to the profile select screen 330.

In some embodiments, the system provides a way for users to regain access to their accounts in the event that they forget their passwords. The “forgot password” functionality initiates the process of password recovery. The user is presented with the option to receive a link via email or an SMS message to their provided phone number. This link directs them to a web page where they can securely change their password and regain control of their account. In some embodiments, the system may allow a free first profile set up and implement a payment system for creating additional profiles.

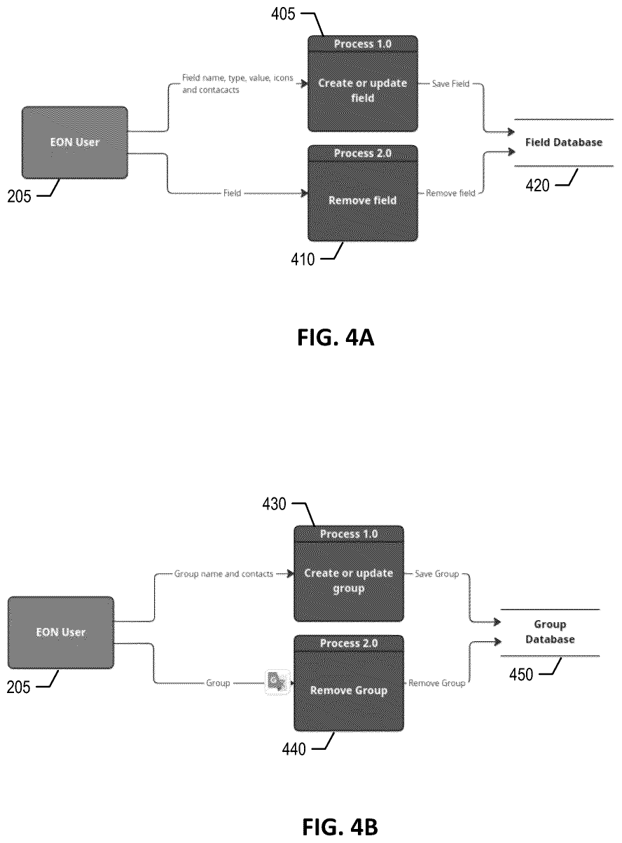

FIG. 4A is a data flow diagram that illustrates an example for managing fields, in accordance with some embodiments of the present disclosure. Fields serve as data elements that encompass various types of supported data and can be added and shared on the platform with the user's contacts. The range of supported data types may include web links (URLs), email addresses, and phone numbers. Third-party APIs may be integrated to enhance the functionality of the fields, allowing users to interact with the third parties in different ways. For example, clicking a link redirects the user to a webpage; clicking an email address opens the default email application with recipient pre-filled; and clicking on phone number fields facilitate SMS or call actions. Additionally, content platform APIs may enable users to access channel information, playlists, and videos, enhancing interactivity enabling direct subscriptions and video playback within the content platform.

For a currently active profile, user 205 is able to create their own fields through a simple intuitive process. User 205 begins by selecting the field type (405), such as a web link, phone number, or email, and proceed to provide the relevant information, such as phone number or email address, along with a descriptive name for the field the case of a web link field, the user specifies the URL, selects an icon from a predefined set, assigns a name to field, and the information is stored in field database 420. In some embodiments, user determines the contacts with whom they wish to share the field, customizing the fie accessibility within their profile and their contacts.

User 205 also has the option to modify and update previously created fields (410), enabling user 205 to change the value associated with each field. The value assigned to a field varies based on its type. For instance, a web link fie value corresponds to a URL, while a phone number field's value represents the phone number itself. Similarly, an email field's value corresponds to the email address. In the case of a web link field, user 205 has the ability to edit the associated icon. In some embodiments, user 205 is provided with the flexibility to adjust the list of contacts with whom they chose to share the field.

In some embodiments, users may selectively share or unshare multiple fields with multiple contacts. Users presented with the ability to choose the desired fields for sharing or unsharing, followed by the selection of contacts whom they wish to share or unshare the fields. This process ensures that the selected fields are shared with all the chosen contacts. If any of the contacts already have access to a field due to prior sharing, no changes will occur. In the case of unsharing, the selected fields are unshared for all the chosen contacts. Lastly, users possess the capability to remove previously created fields, thereby completing the range of functionalities available for managing the fields within the system.

FIG. 4B is a data flow diagram that illustrates an example for managing groups, in accordance with some embodiments of the present disclosure. Groups allow users to categorize their contacts based on criteria. Each user has the ability to create multiple groups (430), assigning them unique names and associating a set of contacts, and storing them in group database 450. Group functionality enables users to efficiently manage their extensive contact lists, or group individuals with whom they frequently interact, such as coworkers, colleagues, and family members.

The system ensures that users have the capability to modify, update, or delete (440) their created groups as needed. This includes the ability to change the name of a group, modify its associated set of contacts, and remove groups entirely from their profile. In addition to the option of modifying the contact list of a group in its entirety, the system provides the capability to individually manage groups associated with a user by accessing their profile as show the section Contact Profile. Users are granted full control and flexibility in managing their groups, allowing them to adjust their organization structure according to their evolving needs.

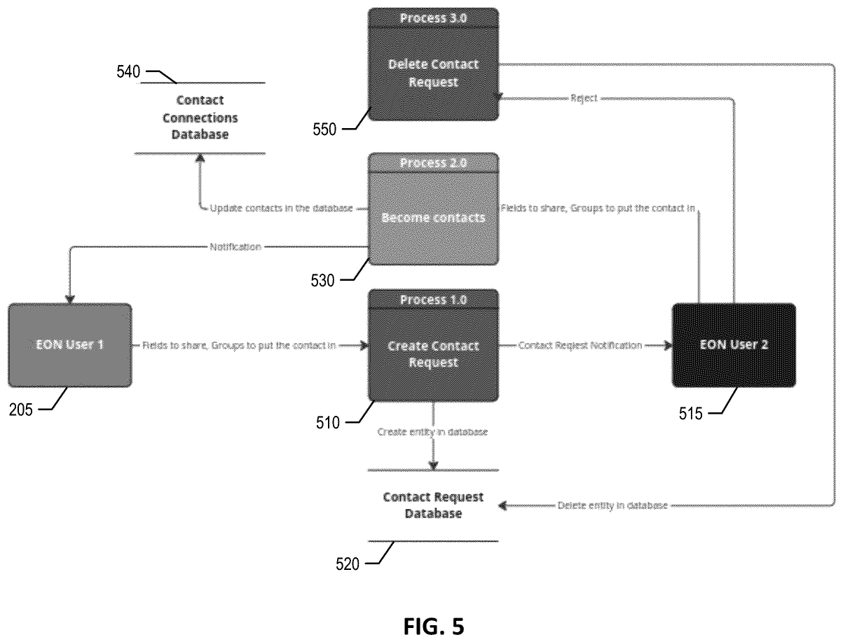

FIG. 5 is a data flow diagram that illustrates an example for creating, accepting, and rejecting contact requests, in accordance with some embodiments of the present disclosure. Contacts serve as a fundamental entity within the system platform and constitute a central component of a contact book. The application seamlessly integrates with the existing local contacts stored on the user's mobile device encompassing contacts stored within the device's internal storage and/or SIM cards (540). Additionally, the system enables users to establish and manage contacts directly within the application.

Users (205, 515) have the option to add new contacts through various approaches. A first approach involves entering phone number and assigning it a corresponding name, akin to the process employed when adding contacts within a native phone book application of the mobile device. Adding a contact automatically synchronizes the contact entry with the user's native phone book application.

A second approach enables a user to add contacts who have registered on the EON platform. A contact request refers to the procedure through which a user expresses their intention to connect and engage with another user on the EON platform, enabling the exchange of fields and inclusion in groups. The contact request (510, 520) can be initiated using various methods. In some embodiments, contact requests involve selecting the desired fields for sharing and determining the groups in which the recipient be placed. The contact request is presented to the recipient, who can either accept (530) or decline (550) the request. Upon acceptance, the recipient has the option to select the fields they wish to share in return and assign the requester to various groups. Following the completion of this process, both users become contacts and gain the ability to interact with each other.

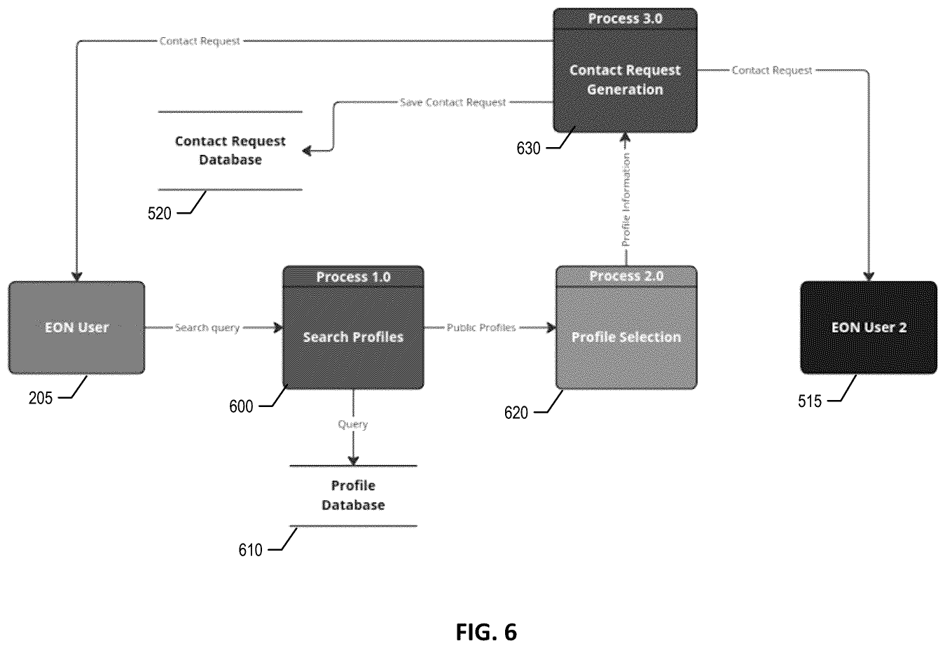

FIG. 6 is a data flow diagram that illustrates an example for befriending a public profile, in accordance with some embodiments of the present disclosure. Users on the EON platform have various means of connecting with other users. The simplest and more direct method is by befriending public profiles. Public profiles are easily discoverable through public searches (600, 610), enabling users to initiate a connection by visiting the profile (620) and selecting the designated button for sending a contact request (630). The streamlined process allows for instant connection without any additional interaction requirements.

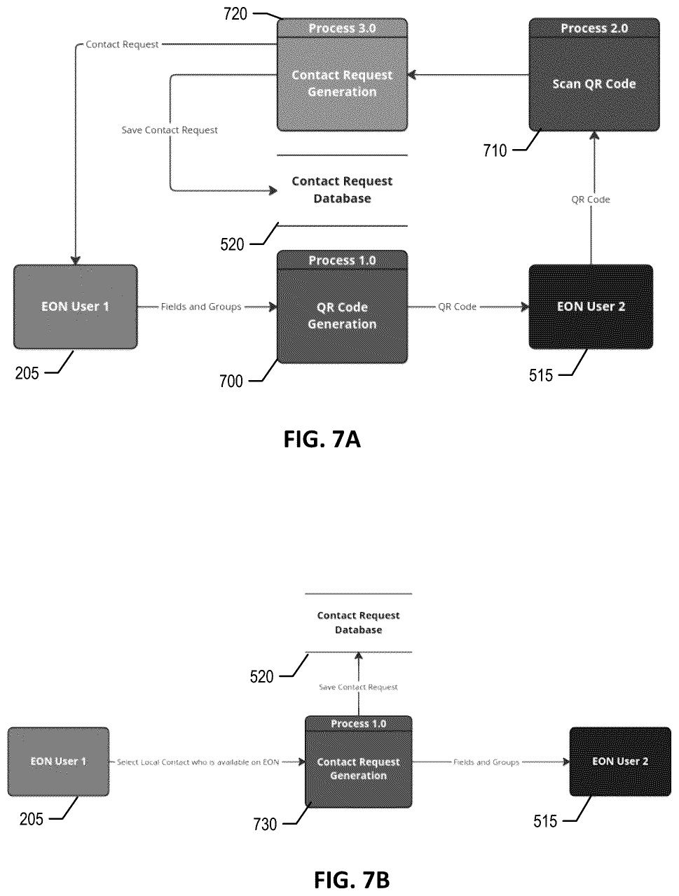

FIG. 7A is a data flow diagram that illustrates an example for befriending a private profile using QR (quick response) codes, in accordance with some embodiments of the present disclosure. A user generating a web link may be wrapped in a QR Code that encapsulates (700) the fields they are willing to share and the groups where they want the recipient to be included. The recipient scans (710) the QR code or clicks the web link, after which a contact request will be automatically generated (720) directed from the QR code generator towards the recipient. The recipient can then proceed to the contact request acceptance process, where they have the option to select the desired fields to share and specify the groups in which to include the contact. This method ensures that the connection is tailored to the preferences and needs of both parties.

FIG. 7B is a data flow diagram that illustrates an example for befriending a local contact, in accordance with some embodiments of the present disclosure. During the registration process, which may require a valid phone number, individuals can associate their EON account to their phone number. As a result, anyone who possesses the phone number associated with an EON-registered individual can initiate a connection (730) with them on the platform by selecting a simple button found in their contact's profile. In some embodiments, the system allows for seam integration between the user's existing contacts and their EON connections.

These various methods of connecting with other users offer flexibility and convenience, ensuring that users establish meaningful connections based on their preferences and existing relationships.

In some embodiments, a home screen of the application prominently displays all contacts, recognizing their central role within platform and ensuring easy accessibility. The contact list provides a comprehensive view of contacts, presenting t profile avatars, display names, and either their EON username or phone number. Within the contact list, a distinction made between contacts established through the EON platform, contacts from the device's phone book without an E account, and contacts from the device's phone book with a registered EON phone number. This distinction is done by different indicators present in the contact entry as shown in FIG. 20. Local contacts imported from the device's phone book are distinguished by the absence of an EON logo next to their names. However, local contacts who have registered on EON and EON contacts are identified with an EON logo. It is important to note that the logo appears faded for 1 contacts who have registered on EON, indicating that the user has the option to send a contact request to establish a connection with them, basically converting them into an EON contact. This is done by visiting the respective contact profile and clicking the designated button for sending a contact request as explained in the previous section.

In some embodiments, each contact within the EON app has its own dedicated screen, providing users with a platform for interaction. When visiting a contact's profile, users not only have the ability to engage with the shared data in the form of the fie but also to manage the connection between themselves and the contact. This includes modifying the contact's assigned groups and adjusting the fields shared with them. Additionally, users have the option to remove the contact from their connections if they no longer wish to maintain the connection on the EON platform.

In some embodiments, offline functionality of a device's phone book is a crucial aspect, as certain interactions such as making calls or sending text messages do not require an internet connection. To ensure its functionality, profiles, contacts, fields, and groups are stored locally on the device, which is facilitated through a synchronization process that harmonizes the data between the EON server and the device's local storage. Whenever the user reconnects to the internet, triggering the synchronization process, the data updates to reflect the latest changes. As such, the user will have access to the most up-to-date data when back online.

In some embodiments, a notifications section within the application functions as a comprehensive repository of historical activity that serves as a centralized hub for receiving real-time updates pertaining to contacts. Notifications are presented as entries providing details such as the timestamp of establishing a new connection, updates made to fields by others, shared field contacts from the user's phone book joining EON, and incoming contact requests. Some of these notifications, in addition to being displayed in the notifications tab, can be delivered to the user as push notifications. Push notifications messages are sent directly to a user's mobile device from an application, even when the user is not actively using the application.

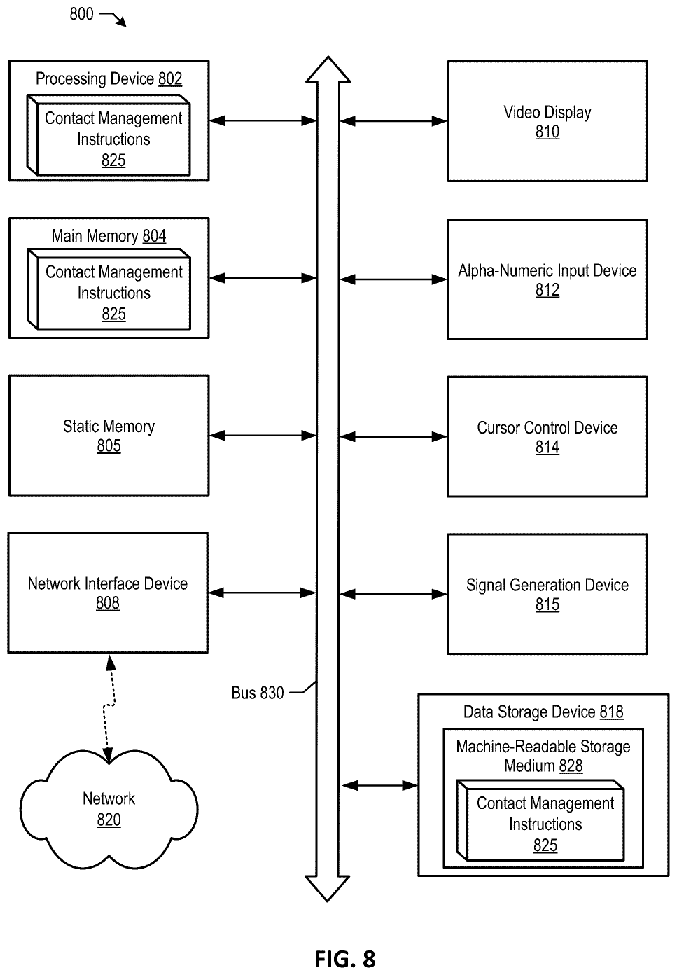

FIG. 8 illustrates a diagrammatic representation of a machine in the example form of a computer system 800 within which a set of instructions, for causing the machine to perform any one or more of the methodologies discussed herein for intelligently scheduling containers.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 800 may be representative of a server.

The example computer system 800 includes a processing device 802, a main memory 804 (e.g., read-only memory (ROM), flash memory, dynamic random access memory (DRAM), a static memory 806 (e.g., flash memory, static random access memory (SRAM), etc.), and a data storage device 818 which communicate with each other via a bus 830. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 800 may further include a network interface device 808 which may communicate with a network 820. The computing device 800 also may include a video display unit 810 (e.g., a liquid crystal display (LCD) or a cathode ray tube (CRT)), an alphanumeric input device 812 (e.g., a keyboard), a cursor control device 814 (e.g., a mouse) and an acoustic signal generation device 816 (e.g., a speaker). In some embodiments, video display unit 810, alphanumeric input device 812, and cursor control device 814 may be combined into a single component or device (e.g., an LCD touch screen).

Processing device 802 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 is configured to execute contact management instructions 825, for performing the operations and steps discussed herein.

The data storage device 818 may include a machine-readable storage medium 828, on which is stored one or more sets of contact management instructions 825 (e.g., software) embodying any one or more of the methodologies of functions described herein. The contact management instructions 825 may also reside, completely or at least partially, within the main memory 804 or within the processing device 802 during execution thereof by the computer system 800; the main memory 804 and the processing device 802 also constituting machine-readable storage media. The contact management instructions 825 may further be transmitted or received over a network 820 via the network interface device 808.

The machine-readable storage medium 828 may also be used to store instructions to perform a method for intelligently scheduling containers, as described herein. While the machine-readable storage medium 828 is shown in an example embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

### Additional Embodiments

A Profile Page allows the user to store his fields (Instagram, Facebook, email, numbers, website etc.). Everything the user stores is private until shared. Today the phone book/contact book profile page does not have this function. The EON Profile is the nucleus to storing a user's fields all in one place. The user is than able to pick 1 or all fields to share with one or all contacts.

Sharing & Un-sharing, Storing & Deleting: With EON a user can share & un share multiple fields with multiple contacts by clicking a few buttons.

With EON a user can store other people's fields by clicking Accept. With EON a user can delete fields and Upload new fields by clicking a few buttons. With EON a user is in control and the user stores fields in a profile. Then when it comes to sharing with a new or current contact a user just shares it. The person the user shares it with does not need to write it down, or write it in his notes, or type in the number himself. the person the user shares it with just needs to click ACCEPT.

Today a user can only share a phone number and an email because the user does not have a place to store anything else like snapchat etc., And if the user wants to share an Instagram with someone, that someone will need to save it by physically writing it in his notes which is not practical. Users live in a world where numbers and emails are not the first thing people always ask for. Which is why today's current contact applications are outdated. EON gives people the opportunity to share and store all types of fields easily. When a user clicks on any contacts the user is guaranteed to have more access to them (not just a number or email), the user is able to have accurate & up to date information.

When the user changes the user's number, the user has the ability to delete it from the user's profile page, which then deletes the number amongst all the contacts that had the number. The user is then able to upload a new number to their profile page, and reshare it with one or all of the user's contacts, seamlessly. And the same process goes with Instagram, Facebook, snapchat etc. . . . the user can share or unshare seamlessly. EON is more access, always precise, and always up to date.

Once a user downloads EON, the user's contacts can always stay up to date. If the user creates a second Facebook, or a third Instagram, if the user starts an online cooking business, the user just uploads all of it on the user's profile, and then shares it with a select few of contacts or all contacts. And every time a contact clicks the user's name the contact will see it.

From a business standpoint, social media influencer, celebrity and gamer standpoint, EON makes it easier than ever to keep clients, customers, and followers up to date with what user's are experiencing. For example, a retail shop has 3 stickers on the front door, or has a business card that reads “Follow our Instagram, follow our Facebook, email us at ****.com.” Customers are limited to that information only. When the customer goes home, and sometime down the road the retail store changes its email, and opens a new Instagram and Facebook account. The customer has no way of knowing about these changes. With EON, the retail shop puts 1 sticker on the door such as “Follow our EON.” Once the customer follows the retail shop's EON account. The customer will always be up to date with the Retail shop because the retail shop's EON will consist of its email, Instagram, Facebook, along with any future new emails, Facebook, and Instagram it creates. If the retail shop creates a snapchat and a twitter account and adds it on EON, the customer will have access to that also!!Seamless access that is everlasting and up to date.

EON has a personal account and a public account. Personal accounts are free & not searchable. Public accounts are not free & and are searchable. A personal account includes contact book where a user stores the numbers of friends and family. When you download EON, at the top of the screen there is a search bar which users can search PUBLIC EON ACCOUNTS only. So, if Stevens Law Firm has a Public account, a user will be able to search it in the Public search bar.

Public accounts can be set to public or private. Regardless if the law firm is set to public or private, users will still be able to see the law firm when searched. The difference is, if set to private, the user that searches for the law firm will need to be accepted by the firm for access to the law firm's page. If the law firm is set to public, the user that searches for the law firm will have automatic access.

When you sign up to EON and create a personal account. No one can search you. No one can find you. Personal accounts are private and not searchable. The only way to connect with a personal account is the same as it is today. By meeting someone in person etc. An example of a public account that would be set to Public would be retail businesses, social media influencers etc. because they want the exposure from their fans and followers to access automatically. No approval process. Examples of public accounts that would be set to private would be lawyers or private companies, that want their clients and employees to be able to follow and be approved to grant them access to the companies' personal numbers, extensions, HR department, emails schedules etc.

The Profile page and its ability to store a user's fields in one place in order for the user to share with its contacts, friends, family, fans, customers, clients, and followers. The ability to share things, and also the different ways. Users have the option of sharing by going to a profile page and clicking on fields to share, users can click directly on a contact to share things, users can generate a QR code and swipe phones with someone else who is the receiver, and users can create links and apply the fields users want to share and send them via email text etc.

### Examples

Exchanging info today person A tells Person B his number, B needs to store it manually, A tells B his email, B needs to store it manually, A tells B his Instagram, B has nowhere to store it. (B always needs to go through the process of storing A's information manually, and then A would also need to manually store B's information) and if ever A or B make changes to their information, both A and B DON'T have a way of knowing.

Exchanging info with EON IS person A clicks on his desired fields that he wants to share with Person B. A clicks send, B clicks Accept. B clicks on desired fields and sends to A, A clicks accept. Fields include numbers of emails Instagram Facebook etc., and if A or B make changes to their information, Both A and B will always know and be updated.

The ability to share a number, email, and Instagram seamlessly. The people users share them with might have notifications on so they will get a notification, or they might have them off. But regardless they will receive what users share without doing anything other than accepting. The ability to delete a number seamlessly and upload a new number seamlessly. Same goes for Instagram Facebook etc., the ability to create new accounts.

Clicking on a contact and not only seeing a lousy number and email. Finally, users see everything contacts want to share. Users can click on a contact and call them, text them, and click on their Facebook (directly reroutes you there Facebook) etc. Personal accounts keep friends and family up to date. Public accounts keep clients, customers, fans, and followers up to date.

Public account example—Justin Bieber has many different social media platforms, not all of which are the same name, Justin Bieber has a website where he sells clothing, Justin Bieber opens new social media platforms, and starts another website where he sells cologne, and Justin Bieber also promotes his music tour calendar, WELL, all I need to do is follow Justin Bieber's EON ACCOUNT to gain access to everything.

The color of the “e” logo near the name may have significance. For example, when a user downloads the app, whoever was already in the user's contact book prior to the download will have a gray E.

The EON application offers smooth synchronization and real-time updates of contact books across devices by utilizing the inherent capabilities offered by the Android and iOS platforms, together with secure communication protocols with a centralized server.

By tracking changes made by an individual user and propagating those updates to their contacts, the system ensures that any modifications, such as switching personal phone numbers, can be effortlessly managed through EON.

Phone number functionality—When a user updates their phone number via EON, all relevant contacts are promptly notified of this change, and the updated phone number is automatically synchronized and shared with the respective contacts, thereby eliminating the need for manual updates.

Profile options—Users are given the option to configure their profile settings as private, making it concealed from external visibility, or public, enabling unrestricted access, which is particularly beneficial for businesses.

Users decide who has access to which field—The platform offers the capability to selectively grant access to specific details for individual contacts, further enhancing the platform's security features and giving users greater control over their shared data.

The advantages extend further with the introduction of a feature that enables users to share themselves and their details with other EON contacts through the convenient methods of scanning QR codes or sharing invite links. With the help of this feature, users may choose the specific information they wish to share, generating a unique QR code or link. Subsequently, the intended recipient can access and establish contact, gaining access solely to the details that have been shared with them.

Creating a contact request—A contact request is when one user wants to connect and engage with another user on the EON platform. This allows them to share information and join specific groups. To make a contact request, users choose what information they want to share and which groups the recipient will be added to. The recipient can then accept or decline the request. If accepted, the recipient can also choose what information they want to share and which groups the requester will be added to. After this process is completed, both users become contacts and can interact with each other.

Connecting to public and private profiles—Users on the EON platform can connect with others in different ways. The easiest and most direct way is by befriending public profiles. These profiles are easy to find through public searches. To connect, users can visit the profile and click a button to send a contact request. This simple process allows for instant connection without any extra steps.

There are two main ways to connect with private profiles in the application. The first approach involves the friend creating a web link that includes the specific information they want to share and the groups they want the recipient to join. This web link can be turned into a QR Code. The recipient can either scan the QR code or click the web link. When they do this, a contact request will be automatically generated and sent from the QR code generator to the recipient. The recipient can then accept the contact request and choose what information they want to share and which groups to include the contact in. This method ensures that the connection is personalized to the preferences and needs of both users.

Contact list functionalities—The home screen of the application prominently displays all contacts, making them easily accessible and recognizing their importance on the platform. The contact list shows a comprehensive view of contacts, including their profile avatars, display names, and either their EON username or phone number. Contacts are categorized into three types: those from the EON platform, those from the device's phone book without an EON account, and those from the device's phone book with a registered EON phone number. The distinction is made clear with different indicators in the contact entry. Local contacts from the phone book have no EON logo next to their names. However, local contacts who have registered on EON and EON contacts are identified with an EON logo. For local contacts who have registered on EON, the logo appears faded, indicating that the user can send them a contact request to establish a full connection and convert them into an EON contact. This is done by visiting the respective contact's profile and clicking the designated button for sending a contact request.

Offline functionality—The device's phone book has an important feature—it works even without an internet connection. EON is designed to function offline too. To make this possible, profiles, contacts, fields, and groups are stored directly on the device. The data is synchronized between the EON server and the device's storage whenever the user connects to the internet. This way, when the user goes online again, the data is updated with the latest changes. There might be a short delay, but once online, the user will have access to the most current information.

Contact Profile—Each contact on the EON app has its own screen for interaction. When you visit a contact's profile, you can engage with the shared data and manage the connection. You can adjust the groups they belong to and the information you share with them. If you no longer want to stay connected, you also have the option to remove the contact from your connections on the EON platform.

How the public account can help social media influencers:

Calling all social media influencers!EON offers an incredible platform to take your influence to new heights and showcase your content like never before. With EON, you have the power to create customized fields that let you share all kinds of content from various social media platforms. From eye-catching images and engaging videos to inspiring blog posts and more, the possibilities are endless!

Seamlessly integrate your online presence and bring all your content under one roof, providing your followers with a centralized hub for everything you have to offer.

Your public profile on EON serves as a powerful tool to enhance your online presence. Easily discoverable through public searches, it enables your followers and potential collaborators to connect with you effortlessly. No more scattered links or confusing navigation—just a simple, unified profile that showcases the best of your content and personality.

EON's contact request system empowers you to connect and engage with your audience in a meaningful way. Initiate collaborations, foster connections with fellow influencers, and expand your network—all through a streamlined and user-friendly process. Grow your community, exchange ideas, and leverage the power of your influence together.

Imagine the impact of having a dedicated screen for each of your contacts on EON. It is a personalized space where you can interact and engage on a deeper level. Share exclusive content, manage your connections, and tailor your interactions to your audience's preferences. With EON, you have all the tools you need to build a strong and loyal community of followers.

So, social media influencers, seize this incredible opportunity to elevate your influence. Embrace EON's seamless integration of various content, leverage your public profile, and expand your connections through the user-friendly contact request system. Join EON now and unlock the true potential of your influence like never before!

Sharing/Managing fields—Each user can easily create their own fields in a simple way. First, you choose the type of field (like Web link, Phone Number, or Email) and provide the relevant information, along with a name for the field. For Web links, you also choose an icon and assign a name. Then, you decide which contacts can see the field. You can update and modify the fields later, changing the information associated with each type of field. For example, a web link field's value is a URL, while a phone number field's value is the phone number itself. You can also edit the icon for web links and adjust the list of contacts that can see the field.

EON allows you to selectively share or unshare multiple fields with multiple contacts. You pick the fields you want to share or unshare and then choose the contacts to share them with. If any of the contacts already have access to the field, there will not be any changes. If you unshare a field, it will be removed from the chosen contacts.

Finally, you have the option to remove previously created fields, giving you full control over managing your fields within the system.

Unless specifically stated otherwise, terms such as “receiving,” “routing,” “updating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

1. A method comprising:
receiving first contact information data from a first user device corresponding to a first user, wherein the first contact information data comprises a plurality of data entries corresponding to a plurality of different platform connection types;
storing the first contact information data on a plurality of second user devices corresponding to a plurality of second users;
detecting a change, on the first user device, to the first contact information data;
in response to detecting the change to the first contact information data, storing the change to the first contact information data on the plurality of second user devices; and
providing a notification to the plurality of second users that indicate the change to the first contact information data.

2. A system comprising:
a memory; and
a processing device, that is operatively coupled to the memory, to:
receive first contact information data from a first user device corresponding to a first user, wherein the first contact information data comprises a plurality of data entries corresponding to a plurality of different platform connection types;
store the first contact information data on a plurality of second user devices corresponding to a plurality of second users;
detect a change to the first contact information data on the first user device;
in response to detecting the change to the first contact information data, store the change to the first contact information data on the plurality of second user devices; and
provide a notification to the plurality of second users that indicate the change to the first contact information data.

3. A non-transitory computer readable medium, storing instructions that, when executed by a processing device, cause the processing device to:
receive first contact information data from a first user device corresponding to a first user, wherein the first contact information data comprises a plurality of data entries corresponding to a plurality of different platform connection types;
store the first contact information data on a plurality of second user devices corresponding to a plurality of second users;
detect a change to the first contact information data on the first user device;
in response to detecting the change to the first contact information data, store the change to the first contact information data on the plurality of second user devices; and
provide a notification to the plurality of second users that indicate the change to the first contact information data.

4. The method of claim 1, wherein the first contact information data comprises a plurality of social media handles that each correspond to one of a plurality of social media platforms that are different from each other.

5. The method of claim 1 wherein the storing of the change to the first contact information data on the plurality of second user devices comprises auto-propagating the change to the first contact information data on the plurality of second user devices.

6. The method of claim 1, wherein the plurality of data entries corresponds to a plurality of fields, and at least one of the plurality of fields is a social media handle field.

7. The method of claim 6, wherein the method further comprises:
sharing a portion of the plurality of fields with one of the plurality of second users based on a selection by the first user; and
sharing a different portion of the plurality of fields with a different one of the plurality of second users based on a different selection by the first user.

8. The method of claim 6, wherein the method further comprises:
generating, by the first user device, a QR (quick response) code encapsulating a portion of the plurality of fields to share with a new user device;
providing the QR code to the new user device; and
in response to the new user device scanning the QR code, sharing a portion of the first contact information data corresponding to the portion of the plurality of fields with the new user device.

9. The method of claim 1, wherein the first user creates a plurality of profiles within a single account, and wherein each one of the plurality of profiles comprises one of a plurality of sets of contacts and customizable data fields to share with the corresponding one of a plurality of sets of contacts.

10. The method of claim 9, wherein each one of the plurality of profiles comprises customizable privacy settings that enable the first user to control a visibility of selected data fields based on a relationship with the corresponding one of a plurality of sets of contacts.

11. The method of claim 9, wherein each one of the plurality of profiles maintains its own synchronized contact information.

12. The system of claim 2, wherein the first contact information data comprises a plurality of social media handles that each correspond to one of a plurality of social media platforms that are different from each other.

13. The system of claim 2, wherein the storing of the change to the first contact information data on the plurality of second user devices comprises auto-propagating the change to the first contact information data on the plurality of second user devices.

14. The system of claim 2, wherein the plurality of data entries corresponds to a plurality of fields, and at least one of the plurality of fields is a social media handle field.

15. The system of claim 14, wherein the processing device is further to:
share a portion of the plurality of fields with one of the plurality of second users based on a selection by the first user; and
share a different portion of the plurality of fields with a different one of the plurality of second users based on a different selection by the first user.

16. The system of claim 14, wherein the processing device is further to:
generate, by the first user device, a QR (quick response) code encapsulating a portion of the plurality of fields to share with a new user device;
provide the QR code to the new user device; and
in response to the new user device scanning the QR code, share a portion of the first contact information data corresponding to the portion of the plurality of fields with the new user device.

17. The system of claim 2, wherein the first user creates a plurality of profiles within a single account, and wherein each one of the plurality of profiles comprises one of a plurality of sets of contacts and customizable data fields to share with the corresponding one of a plurality of sets of contacts.

18. The non-transitory computer readable medium of claim 3, wherein the first contact information data comprises a plurality of social media handles that each correspond to one of a plurality of social media platforms that are different from each other.

19. The non-transitory computer readable medium of claim 3, wherein the storing of the change to the first contact information data on the plurality of second user devices comprises auto-propagating the change to the first contact information data on the plurality of second user devices.

20. The non-transitory computer readable medium of claim 3, wherein the plurality of data entries corresponds to a plurality of fields, and at least one of the plurality of fields is a social media handle field, and wherein the processing device is further to:
share a portion of the plurality of fields with one of the plurality of second users based on a selection by the first user; and
share a different portion of the plurality of fields with a different one of the plurality of second users based on a different selection by the first user.
